(19) United States
(12) Patent Application Publication
(10) Pub. No.: US 2009/0235355 A1
(43) Pub. Date: Sep. 17, 2009

(54) NETWORK INTRUSION PROTECTION SYSTEM

(75) Inventors: Yi CHEN, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/049,890

(22) Filed: Mar. 17, 2008

(51) Int. Cl. G06F 21/00

(52) U.S. Cl. 726/23

(57) ABSTRACT

A network intrusion protection system (NIPS) is built at an important network node, for example, at a boundary router, for filtering network packets containing malicious intrusion/attacking behaviors. A network card of the NIPS includes a microprocessor, a network packet decode procedure and a malicious intrusion packet filtering procedure, for filtering malicious network packets in advance according to header information of the network packets. Then, a central processor of the NIPS is used to parse the contents in the rest network packets, and determine whether the network packets are malicious packets according to an intrusion behavior definition file. The network packets are discarded if the network packets are malicious. Otherwise, the network packets are transferred to computers in internal local area network if the network packets not malicious.

### BACKGROUND OF THE INVENTION

1. Field of Invention

The present invention relates to a network intrusion protection system (NIPS), and more particularly to a network intrusion protection system (NIPS) having a microprocessor built on a network card so as to accelerate the execution of an intrusion protection function.

2. Related Art

Development and popularity of network technology enables network to become prevailing to life. People rapidly exchange information through the network. However, Internet is not always secure. For example, hackers may intrude computer systems to steal data or damage the computer systems. Currently, most users use antivirus softwares or firewalls to protect computers against computer viruses or man-made intrusions and damages. One technology named network intrusion detection system (NIDS) may be used to monitor network activities, so as to protect computers within the network against malicious attacks and damages. The network intrusion detection system is a passive network security system, which discovers abnormal network activities through analyzing network packets and then sends an alert in real time to inform a network administrator to handle/reject the abnormal network activities. In order to instantly block malicious intrusions and attacks from network, the NIPS is developed to provide active protection for the network security technology. All network packets must pass the NIPS and are transferred to the protected internal local area network (network segment) until no abnormal activities or suspicious contents are confirmed. Compared with the network intrusion detection system, the NIPS is capable of rejecting network attacking behaviors before the occurrence of malicious intrusions, thereby protecting computer systems within the network against damages.

However, with the improvement of network technology and increase of quantity of exchanged data, heavy network flow gradually becomes burden for the NIPS. Since the NIPS must capture and analyze each network packet, and let the network packet not pass until ensuring that the network packets does not contain malicious contents. If the response ability of the NIPS cannot keep up with the transmission speed of the network, the fluency of the internal network in data access may be influenced, thereby greatly reducing the performance of the internal network.

### SUMMARY OF THE INVENTION

In order to solve the problem that the transmission of packets is delayed due to the poor response ability of the NIPS, the present invention is directed to provide a new architecture of NIPS (“system” below for short), which filters harmful or malicious network packets flowing through local area network through the processing of a microprocessor and a central processing unit (CPU), thereby achieving the effect that the system accelerates filtering the network packets.

In order to achieve the aforementioned objectives, the system of the present invention at least includes a network card with a microprocessor, and a CPU. The network card receives network packets from the outside of the local area network. The network card further has two built-in firmware procedures, namely a network packet decode procedure executed by the microprocessor to parse communication protocols, source addresses, and connection port numbers of network packets, and a malicious packet filtering procedure also executed by the microprocessor to determine whether the network packets are malicious network packets according to the parsing results and an intrusion packet definition file of the network packet decode procedure, in which if yes, then filter them. The rest unfiltered network packets will be processed by the CPU. The CPU executes the following procedures. Firstly, the packet contents of the rest network packets are parsed. Then, the network packets are determined whether to be malicious network packets according to the intrusion packet definition file and the parsed packet contents of the rest network packets. After that, the malicious network packets are filtered, and the rest normal network packets are transferred to computers within the internal local area network through the network card.

In the NIPS according to a preferred embodiment of the present invention, the network card further includes a memory for temporarily storing network packets. In addition, a primary memory in the system is used to store the parsed packet contents of the network packets.

In the NIPS according to a preferred embodiment of the present invention, the intrusion packet definition file includes multiple predefined intrusion behavior rules and corresponding default communication protocols, source addresses, and connection port numbers. The network administrator may further modify the intrusion behavior rules and the corresponding default communication protocols, source addresses, and connection port numbers of the intrusion packet definition file through a user interface.

In the NIPS according to a preferred embodiment of the present invention, corresponding intrusion behavior rules are automatically added to the intrusion packet definition file according to the communication protocols, source addresses, and connection port numbers of filtered malicious intrusion network packets. In addition, the network packet decode procedure points to data segments of the network packets through multiple structure pointers, thereby quickly parsing the communication protocols, source addresses, and connection port numbers of the network packets.

In the NIPS according to a preferred embodiment of the present invention, the microprocessor further includes processing default communication protocols, source addresses, or connection port numbers defined by the intrusion packet definition file through a plurality of threads. In addition, the CPU also processes other intrusion behaviors defined by the intrusion packet definition file respectively through the threads.

Based on the above, the system provided by the present invention firstly filters the malicious intrusion network packets by using the microprocessor on the network card, and the CPU then filters the malicious intrusion network packets among the rest network packets. Because the microprocessor on the network card and the CPU of the system work individually and simply filter the network packets and further parse the packet contents, thereby the system accelerates the speed of processing the network packets, so as to solve the problems in the current system that the network transmission speed is affected and the packet transmission is delayed.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a network topology of the NIPS according to a preferred embodiment of the present invention; and

FIG. 2 is a schematic system architectural view of the NIPS according to a preferred embodiment of the present invention.

### DETAILED DESCRIPTION OF THE INVENTION

The objectives of the present invention will be illustrated in detail in the following preferred embodiment. However, the concept of the present invention may also be used in other scopes. The following embodiments are used to illustrate the objectives and implementation methods of the present invention, and are not intended to limit the scope of the present invention.

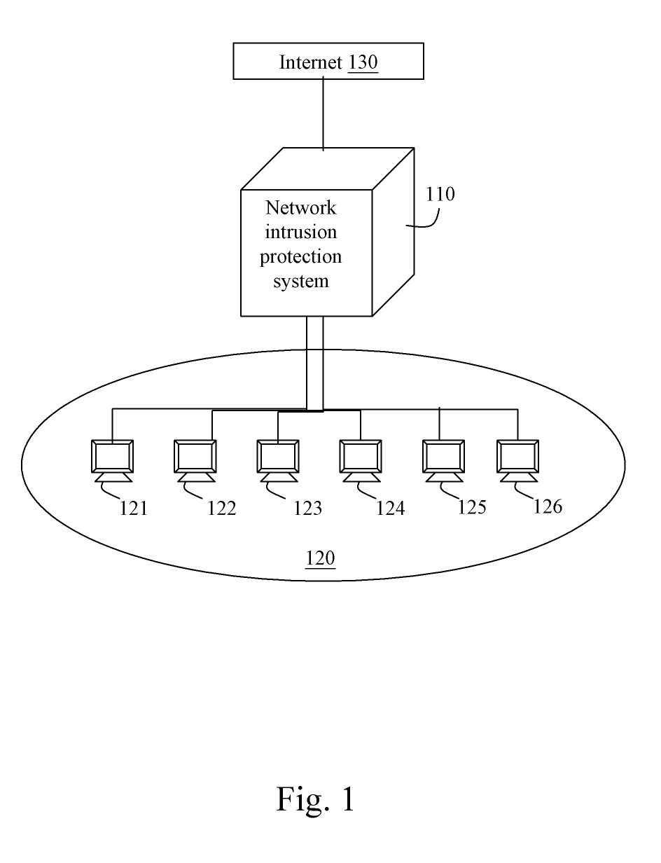

FIG. 1 is a schematic view of a network topology of the NIPS according to a preferred embodiment of the present invention. Referring to FIG. 1, in this embodiment, since all network packets will flow through a boundary node, a NIPS 110 (“the system 110” below for short) is built at a boundary node (or a boundary router) of, for example, a local area network 120, so as to filter network packets (“malicious packets”) with the contents of malicious intrusion/attacking behaviors, so as to protect computers (121-126) in the local area network 120 from being attacked by the malicious packets from Internet 130.

The most significant difference between the system of the present invention and the current system lies in that a network card within the system provided by the present invention has a microprocessor. The microprocessor executes a firmware burned on a memory block (for example, a read-only memory (ROM)) on the network card in advance, so as to parse header information of the received network packets, and quickly filter the malicious network packets according to the header information. For example, the system in the preferred embodiment of the present invention has the following architecture.

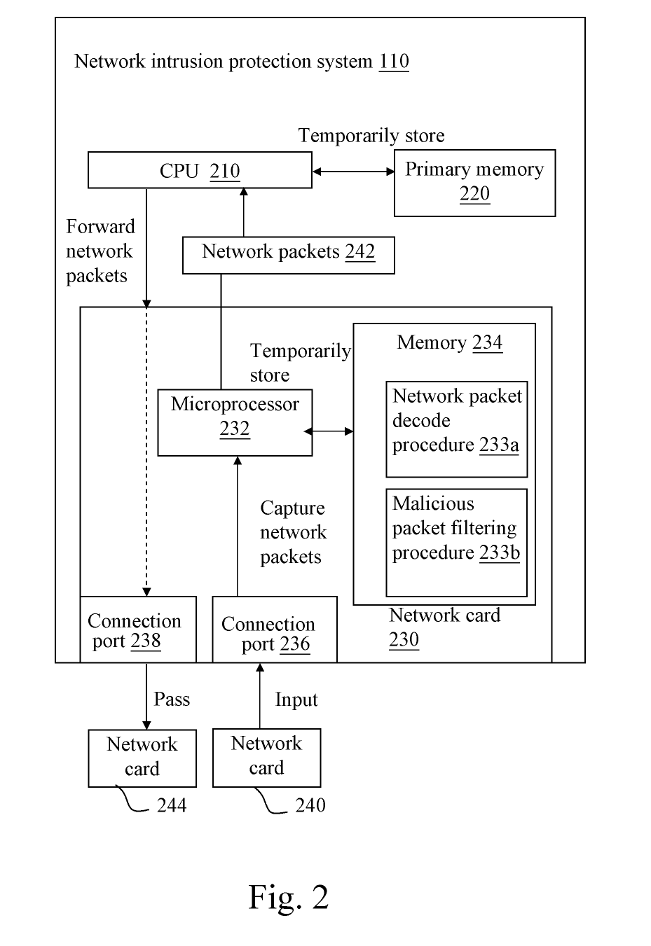

FIG. 2 is a system architectural view of the NIPS according to a preferred embodiment of the present invention. Referring to FIG. 2, the system 110 has a CPU 210 and a network card 230. The network card 230 includes a microprocessor 232, a network packet decode procedure 233a, a malicious packet filtering procedure 233b, a memory 234, and two connection ports (236, 238). The network packet decode procedure 233a and the malicious packet filtering procedure 233b may be stored in advance in a storage space of the system 110, for example, a hard disk, and loaded into the memory 234 when the system 110 runs.

The network card 230 receives multiple network packets 240 through the connection ports 236, and meanwhile, the microprocessor 232 executes the network packet decode procedure 233a to parse the communication protocols, the source addresses, and the connection port numbers of the network packets 240. The communication protocols, the source addresses, and the connection port numbers may be obtained through parsing the data segments of the headers of the network packets 240. Then, the microprocessor executes the malicious packet filtering procedure 233b to determine whether the network packets 240 are malicious packets based on the communication protocols, source addresses, and connection port numbers parsed by the network packet decode procedure 233a according to the intrusion packet definition file (not shown) and filters the malicious packets as soon as possible.

Next, the rest plurality of network packets (i.e., network packets 242) is transferred to the CPU 210 to further parse the packet contents. The CPU 210 executes the following procedures. Firstly, the packet contents of the network packets 242 are parsed. Next, according to the rules recorded in the preset intrusion packet definition file, the packet contents of the network packets 242 is analyzed so as to determine whether the network packets 242 are malicious packets. The network packets are directly filtered, if the network packets 242 are malicious packets. The normal network packets (i.e., network packets 244) are transferred to the computers in the internal local area network through the network card 230 and the connection port 238, if the network packets 242 are normal network packets (i.e., the packet contents do not contain the malicious packet rules defined by the intrusion packet definition file).

The network card 230 of the system 110 further includes a memory 234, for temporarily storing multiple received network packets 240, so as to avoid the phenomenon of packet lose since the system 110 processes the network packets too slowly. The processed network packets 242 may also be temporarily stored in the memory 234, and then accessed by the CPU 210; or directly transported to a primary memory 220 in the system 110 or other storage spaces (such as hard disks). The normal network packets 244 that should be forwarded to the local area network may also be temporarily stored in the memory 234, so as to avoid the packet lose when the network is congested. In addition, the primary memory 220 may temporarily store the packet contents of the network packets 242 further parsed by the CPU 210, so as to facilitate the CPU 210 to analyze the intrusion behavior distributions of the packet contents (for example, analyze the percentages of various intrusion behaviors in the network packets among the intrusion/attacking network packets).

In this embodiment, the network packet decode procedure may point to the data segments of the network packets through the defined structure pointers, thereby quickly parsing the communication protocols, the source addresses, and the connection port numbers of the network packets. For example, a hook function is used to point to the positions of the bits of the communication protocol fields in the network packet headers, and the data segments of the widths of the communication protocol fields are obtained to acquire the communication protocols of the network packets. In fact, the steps may be performed through a netfilter. Each of the network packets 240 flowing through the system 110 may be blocked by the netfilter, and then the communication protocols, the source addresses, and the connection port numbers of the network packets 240 may be obtained.

In view of the above, the intrusion packet definition file includes multiple predefined intrusion behavior rules, and the default communication protocols, source addresses, and connection port number corresponding to the intrusion behavior rules. For example, known network hackers may use the DOS manner to transmit a mass of NOP instructions through a specific connection port (such as port number 80) of the server of the web browser. Therefore, we can write an intrusion behavior rule into the intrusion packet definition file in advance, and if the NOP instructions transmitted through the TCP communication protocol accessing connection port (port number 80) is greater than a threshold, it is determined to be the intrusion behavior. In addition, a network administrator may modify the intrusion behavior rules in the intrusion packet definition file through a user interface, or add new intrusion behavior rule. Likewise, the intrusion behavior rules also include default communication protocols, source addresses, and connection port numbers.

In some embodiments, the CPU 210 generates an intrusion behavior rule according to the communication protocols, source addresses, and connection port numbers of the malicious packets, and automatically adds the rule into the intrusion packet definition file, before filtering the malicious packets (i.e., before determining the network packets 241 are malicious packets and filtering them). In addition, in order to accelerate the processing of the network packets, the microprocessor 232 may process a single type of communication protocols (for example TCP and UDP communication protocols) through a plurality of threads, and determine whether the network packets are malicious ones according to the source addresses and connection port numbers. Likewise, the CPU may also set a plurality of threads to process different intrusion behavior items one by one (i.e., predefined determination items of the intrusion packet definition file), so as to conveniently calculate the distribution of each intrusion behavior.

What is claimed is:

1. A network intrusion protection system at a node in a local area network for filtering network packets containing contents of malicious intrusion/attacking behaviors, the network intrusion protection system at least comprising:
a network card, receiving a plurality of network packets, the network card comprising:
a microprocessor;
a network packet decode procedure, executed by the microprocessor to parse the communication protocols, source addresses, and connection port numbers of the network packets;
a malicious packet filtering procedure, executed by the microprocessor, for determining whether the network packets are malicious network packets according to parsing results of the network packet decode procedure and an intrusion packet definition file and then filtering the malicious network packets; and
a CPU, for processing following procedures:
parsing packet contents of the rest network packets;
determining whether the network packets are malicious network packets according to the intrusion packet definition file and the packet contents of the rest network packets; and
filtering the malicious network packets, and transmitting the rest normal network packets to computers in an internal local area network through the network card.

2. The network intrusion protection system as claimed in claim 1, wherein the network card further comprises a memory for temporarily storing the network packets.

3. The network intrusion protection system as claimed in claim 1, wherein the network intrusion protection system further comprises a primary memory for temporarily storing the packet contents of the parsed network packets.

4. The network intrusion protection system as claimed in claim 1, wherein the intrusion packet definition file comprises a plurality of intrusion behavior rules and default communication protocols, source addresses, and connection port numbers corresponding to the intrusion behavior rules.

5. The network intrusion protection system as claimed in claim 1, wherein the CPU further automatically adding the corresponding intrusion behavior rules to the intrusion packet definition file according to the communication protocols, source addresses, and connection port numbers of filtered malicious intrusion network packets.

6. The network intrusion protection system as claimed in claim 1, wherein the network packet decode procedure points to data segments of the network packets through a plurality of structure pointers, thereby quickly parsing communication protocols, source addresses, and connection port numbers of the network packets.

7. The network intrusion protection system as claimed in claim 1, further comprising a user interface for modifying the intrusion behavior rules of the intrusion packet definition file and the corresponding default communication protocols, source addresses, and connection port numbers.

8. The network intrusion protection system as claimed in claim 1, wherein the microprocessor further comprises respectively processing the default communication protocols, source addresses, or connection port numbers defined by the intrusion packet definition file one by one through a plurality of threads.

9. The network intrusion protection system as claimed in claim 1, wherein the CPU further comprises respectively processing the intrusion behavior items defined by the intrusion packet definition file one by one through the threads.
